(19) United States
(12) Patent Application Publication
(10) Pub. No.: US 2011/0145542 A1
(43) Pub. Date: Jun. 16, 2011

(54) Apparatuses, Systems, and Methods for Reducing Translation Lookaside Buffer (TLB) Lookups

(75) Inventor: Michael William Morrow, Cary, NC (US)

(73) Assignee: QUALCOMM INCORPORATED, San Diego, CA (US)

(21) Appl. No.: 12/638,340

(22) Filed: Dec. 15, 2009

(51) Int. Cl. G06F 12/10; G06F 12/00

(52) U.S. Cl. 711/207; 711/E12.001; 711/E12.061

(57) ABSTRACT

Circuits and related systems and methods for providing virtual address translation are disclosed. In one embodiment, a circuit comprises a comparator configured to receive as an input a current virtual address and a current attribute associated with the current virtual address, and a prior physical address and a prior virtual address each associated with the current attribute. The comparator is further configured to cause the prior physical address to be provided as a current physical address if the current virtual address matches the prior virtual address associated with the current attribute. As an example, the circuit may be a TLB suppression circuit configured to reduce TLB lookups. Reducing TLB lookups can reduce power dissipation. In this regard, the circuit may also be further configured to suppress a TLB lookup to reduce power dissipation when the current virtual address matches the prior virtual address.

### BACKGROUND

I. Field of the Disclosure

The technology of the disclosure relates generally to translation lookaside buffers (TLBs) and TLB lookups.

II. Background

Central processing units (CPUs) typically support virtual memory management. In virtual memory management, a virtual memory address is translated or mapped into an actual physical address in physical memory. The process of translating virtual addresses into physical addresses is called virtual address translation. Virtual address translation incurs CPU clock cycles for each translation performed thus impacting performance of the CPU. To improve virtual address translation speed, a translation lookaside buffer (TLB) cache may be employed in the CPU. A TLB cache has a number of storage locations that contain page table entries, which map virtual addresses to physical addresses. For example, a TLB cache may be implemented as a content-addressable memory (CAM) in which a search key is a virtual address and a search result of the CAM is a physical address. The virtual address is compared to virtual address entries. If the virtual address to be translated is present in the TLB, a TLB hit occurs and the retrieved physical address can be used to access memory. This is called a TLB hit. If the virtual address to be translated is not present in the TLB, a TLB miss occurs and virtual address translation proceeds by looking up the page table in a process called a page walk.

Although TLBs improve virtual address translation speed, each comparison of the virtual address to be translated to entries in the TLB dissipates power. The more a memory access regime relies upon repeated TLB lookups, the greater the number of comparisons and resultant power dissipation. However, it is often desired to reduce power dissipation in CPUs, especially if the CPU is employed in a battery-operated or handheld device. It is therefore desired to provide fast virtual address translation while also reducing or minimizing power dissipation.

### SUMMARY OF THE DISCLOSURE

Circuits and related systems and methods for performing virtual address translation are disclosed. In one embodiment, a circuit for performing virtual address translation is provided. The circuit in this embodiment comprises a comparator configured to receive as an input a current virtual address and a current attribute associated with the current virtual address, and a prior physical address and a prior virtual address each associated with the current attribute. The comparator is further configured to cause the prior physical address to be provided as a current physical address if the current virtual address matches the prior virtual address associated with the current attribute. As an example, the circuit may be a translation lookaside buffer (TLB) suppression circuit configured to reduce TLB lookups. TLB lookups are performed to translate virtual addresses into physical addresses. Reducing TLB lookups can reduce power dissipation thus reducing power dissipation of a central processing unit (CPU) or system. In this regard, the circuit may be further configured to suppress a TLB lookup to reduce power dissipation if the current virtual address matches the prior virtual address associated with the current attribute.

In another embodiment, a method of providing virtual address translation is disclosed. The method may include reducing TLB lookups, as an example. The method comprises receiving as an input a current virtual address and a current attribute associated with the current virtual address. The method further comprises receiving both a prior physical address and a prior virtual address each associated with a current attribute. The prior physical address is provided as a current physical address if the current virtual address matches the prior virtual address associated with the current attribute.

### BRIEF DESCRIPTION OF THE FIGURES

FIG. 1 is a schematic diagram of an exemplary translation lookaside buffer (TLB) lookup suppressor included in an exemplary central processing unit (CPU);

FIG. 2 is a flowchart illustrating an exemplary operation of the TLB lookup suppressor in FIG. 1;

FIG. 3 is a table illustrating exemplary sequences of virtual addresses for information requests provided to the TLB lookup suppressor of FIG. 1, and whether a TLB lookup occurred as a result of the current virtual address matching or not matching a prior virtual address;

FIG. 4 is a table illustrating the exemplary sequences of virtual addresses provided in the table in FIG. 3, and whether a TLB lookup occurred as a result of the current virtual address matching or not matching a prior virtual address for the current attribute of the current virtual address;

FIG. 5 is a schematic diagram of another exemplary TLB lookup suppressor and CPU;

FIG. 6 is a flowchart illustrating an exemplary operation of the TLB lookup suppressor of FIG. 5;

FIG. 7 is a schematic diagram of another exemplary TLB lookup suppressor arranged for virtually indexed, virtually tagged (VIVT) memory; and

FIG. 8 is a block diagram of an exemplary microprocessor-based system employing a TLB lookup suppressor according to any of the exemplary embodiments.

### DETAILED DESCRIPTION

With reference now to the drawing figures, several exemplary embodiments of the present disclosure are described. The word “exemplary” is used herein to mean “serving as an example, instance, or illustration.” Any embodiment described herein as “exemplary” is not necessarily to be construed as preferred or advantageous over other embodiments.

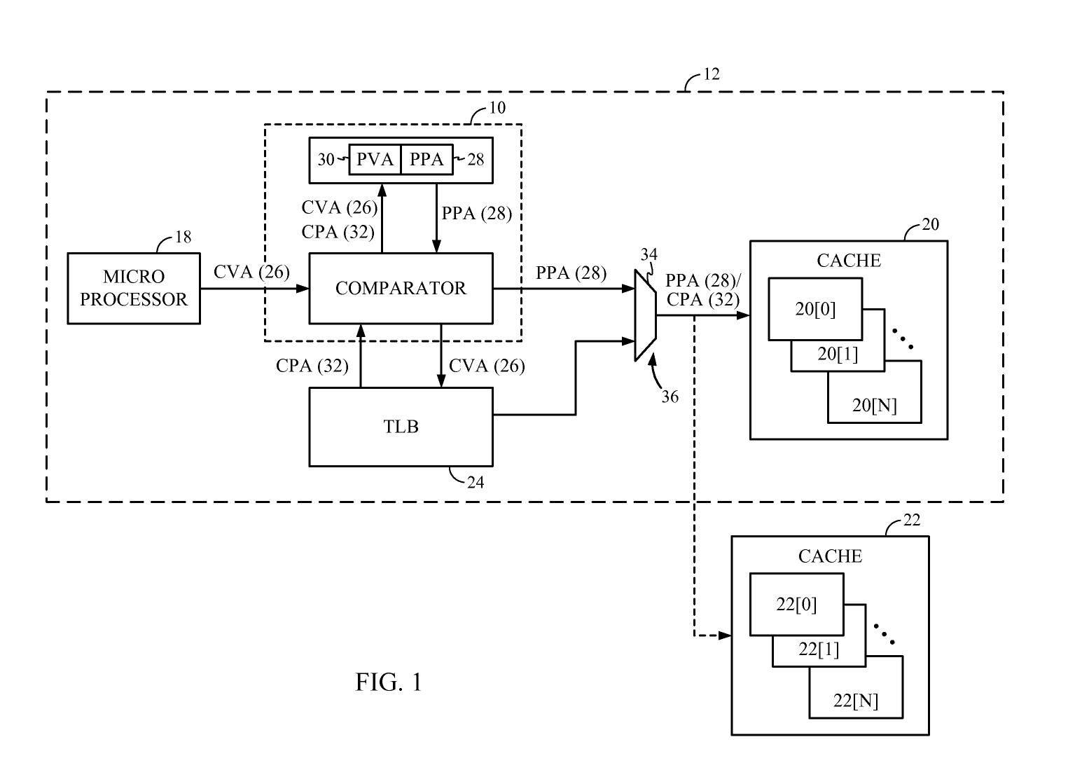

FIG. 1 is a schematic diagram of one embodiment of a TLB lookup suppressor 10. In this embodiment, the TLB lookup suppressor 10 is a circuit forming a part of a central processing unit (CPU) or CPU system 12 (referred to herein as “CPU 12”) although such is not required. The TLB lookup suppressor 10 includes at least one comparator 14 and at least one register 16 to facilitate virtual address translation, as described in more detail below. During operation, a microprocessor 18 can request data or instructions from a memory such as L1 cache 20, L2 cache 22 or other memory system to which the microprocessor 18 is coupled, as examples. The requests made by the microprocessor 18 may request data or instruction information by a virtual address (VA). In order to access the location at which the data or instruction information resides, the virtual address is translated into a physical address (PA) via virtual address translation. The physical address can be used to index the location of the information requested. An additional TLB (not shown) may be provided to separately index the cache 22, if desired. If the requested information is resident in the caches 20, 22, the process of retrieving the requested data from a main memory is avoided. The caches 20, 22 are physically indexed, physically tagged (PIPT) in this embodiment, but could also be virtually indexed, virtually tagged (VIVT) as another example, as will be described in more detail below.

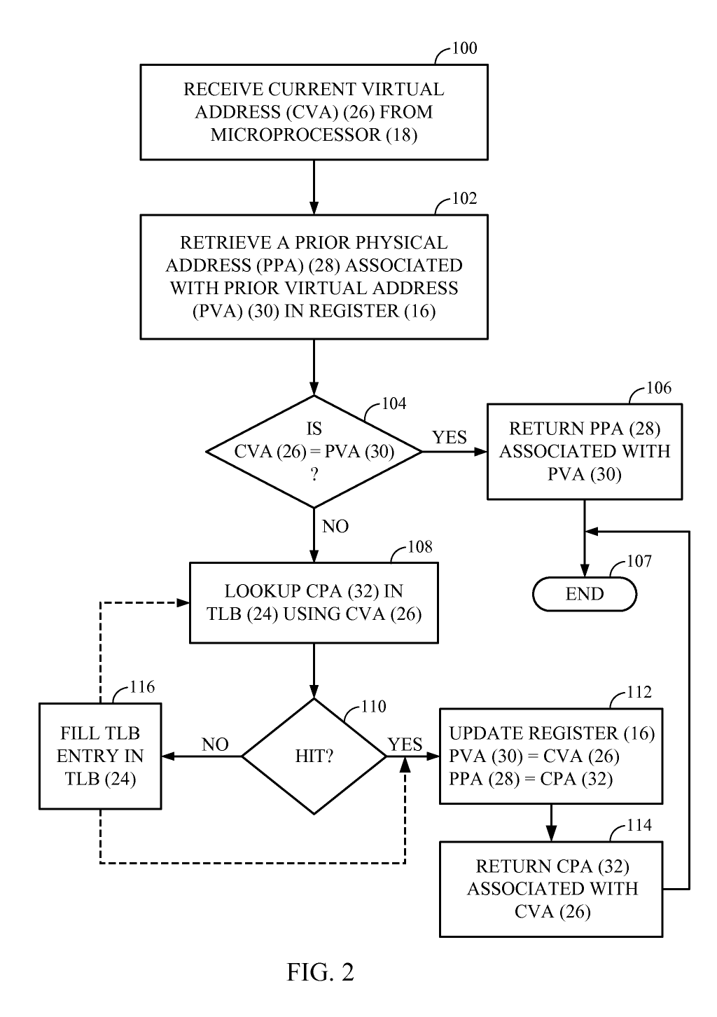

With continuing reference to FIG. 1, the virtual addresses for information requests generated by the microprocessor 18 are translated into physical addresses. In this regard, as illustrated in FIG. 1, a translation lookaside buffer (TLB) 24 is included in the CPU 12 in this embodiment to perform virtual address translation. The TLB 24 may contain a table or other form of memory (not shown), such as a content addressable memory (CAM) for example, to lookup physical addresses that are associated with virtual addresses. The physical addresses resulting from translated virtual addresses are used to physically index the caches 20, 22 or other memory to retrieve the information stored at the physical addresses. In order to perform such virtual address translation in this embodiment, the TLB lookup suppressor 10 operates to intercept or otherwise receive requests for information from the microprocessor 18 before the virtual address for the information requested is provided to the TLB 24, as illustrated in FIG. 1. In this regard, the operation of the TLB lookup suppressor 10 in FIG. 1 is described in conjunction with the operation in the flowchart of FIG. 2.

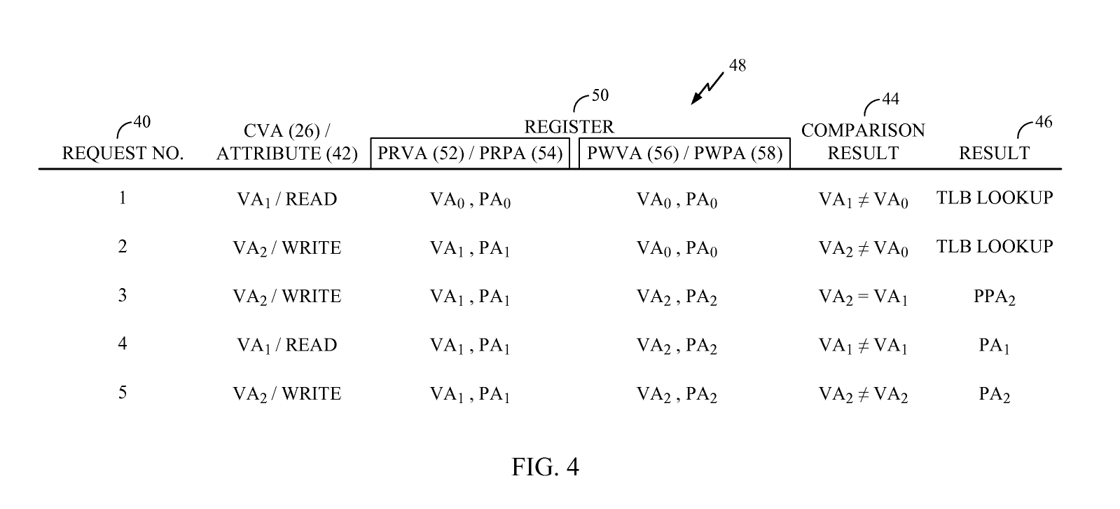

As illustrated in FIG. 1 and provided in block 100 in FIG. 2, the TLB lookup suppressor 10 receives a current virtual address (CVA) 26 for accessing information in the cache 20 or cache 22. The CVA 26 is the virtual address for the information currently requested by the microprocessor 18. The comparator 14 of the TLB lookup suppressor 10 retrieves a prior physical address (PPA) 28 previously associated with a prior virtual address (PVA) 30 stored in the register 16 (block 102 in FIG. 2). In this embodiment, the register 16 provides a single entry for storing the PPA 28 associated with the PVA 30 regardless of the attribute that was associated with the information request that generated the PVA 30. An attribute can be additional information about the request, such as its function (e.g., a read or write), or can also be an originator such as a supervisor or user code. In other embodiments, multiple entries could be provided in a register for different attribute types wherein the register is consulted for the PPA 28 based on the PVA 30 and the attribute. Providing entries for PVAs 30 and associated PPAs 28 in a register for different attributes may further reduce TLB lookups if successive information requests from the microprocessor 18 having the same attribute include the same virtual address. This is discussed in more detail below with regard to exemplary embodiments provided in FIGS. 4-7.

With reference back to FIGS. 1 and 2, the comparator 14 next determines if the CVA 26 in the information request from the microprocessor 18 is the same virtual address as the PVA 30 stored in the register 16 (block 104 in FIG. 2). If the comparator 14 determines that the CVA 26 is the same as the PVA 30 (block 104 in FIG. 2), this means that the register 16 already contains the physical address (i.e., the PPA 28) associated with the CVA 26. In this regard, a TLB lookup in the TLB 24 to translate the CPA 26 to a physical address is not required since the PPA 28 associated with the PVA 30 is the same as the CVA 26. Therefore, a TLB lookup is suppressed in the TLB 24 and the power required to perform the TLB lookup is saved. The TLB lookup suppressor 10 can then output or otherwise provide the stored PPA 28 as the physical address to index the caches 20, 22 or other memory, as illustrated in FIG. 1 (block 106 in FIG. 2), and the virtual address translation process ends (block 107 in FIG. 2).

If, however, it is determined that the CVA 26 is not the same as the retrieved PVA 30 stored in the register 16 (block 104 in FIG. 2), this means the register 16 did not contain a record of the physical address (i.e., PPA 28) associated with the CVA 26. In this regard, the TLB lookup suppressor 10 provides the CVA 26 to the TLB 24 to translate the CVA 26 into a current physical address (CPA 32) by performing a TLB lookup (block 108 in FIG. 2). A TLB lookup is performed in this scenario, because the register 16 did not contain the physical address (i.e., PPA 28) associated with the CVA 26 (as determined in block 104 in FIG. 2). A determination is then made as to whether the TLB 24 was able to translate the CVA 26 into a corresponding physical address (i.e., CPA 32) (block 110 in FIG. 2). As previously discussed, this may involve the TLB 24 performing a series of comparisons to attempt to match the CVA 26 to virtual addresses stored in the TLB 24. Power is dissipated for each comparison performed.

If the CVA 26 is present in the TLB 24, this means a “hit” has occurred as a result of the TLB lookup. As a result, the TLB 24 communicates the resultant translated physical address (i.e., CPA 32) to the comparator 14 to be stored in the register 16 for the PVA 30 as the PPA 28 (i.e., PVA (30)=CVA (26); PPA(28)=CPA (32)) in case the virtual address (i.e., CVA 26) for subsequent information requests from the microprocessor 18 matches the PPA 28 stored in the register 16 (block 112 in FIG. 2). In this case, a TLB lookup in the TLB 24 will not be required to perform virtual address translation on the subsequent CVA 26 provided by the microprocessor 18, as discussed above with regard to blocks 100-107 in FIG. 2. After the physical address (i.e., CPA 32) associated with the CVA 26 is retrieved as a result of the TLB hit, the TLB 24 can then output or otherwise provide the CPA 32 as the physical address to index the cache 20, 22 or other memory, as illustrated in FIG. 1 (block 114 in FIG. 2), and the virtual address translation process ends (block 107 in FIG. 2). If the TLB lookup in the TLB 24 (block 108 in FIG. 2) does not result in a hit (block 110 in FIG. 2), the TLB entry in the TLB 24 corresponding to the CVA 26 is filled in with the physical address corresponding to the CVA 26 (i.e., CPA 32) (block 116 in FIG. 2). For example, the TLB entry for the CVA 26 may be generated via a memory page walk.

After the TLB entry for the CVA 26 is generated and filled in the TLB 24 (block 116), the process may repeat the TLB lookup in block 108, as illustrated in the dashed line from block 116 to block 108 in FIG. 2. Alternatively, as illustrated by the dashed line from block 116 to block 112 in FIG. 2, a bypass may be provided to provide the TLB entry for the CVA 26 as the CPA 32 to update the register 16 (block 112) and provide as the physical address for indexing into the caches 20, 22 or other memory. Bypassing the TLB lookup (block 108) after a TLB miss (block 110) may save clock cycles over performing an additional TLB lookup (block 108) after the TLB entry based on the CVA 26 is filled in the TLB 24 (block 116).

As described above with regard to FIGS. 1 and 2, where a TLB hit occurs, the physical address for the CVA 26 provided by the microprocessor 18 as part of the information request will either be provided as the PPA 28 by the TLB lookup suppressor 10 or the CPA 32 by the TLB 24. As illustrated in FIG. 1, in this embodiment, a selector 34 is provided to either select the PPA 28 from the TLB lookup suppressor 10 or the CPA 32 from the TLB 24 as the physical address provided to index the caches 20, 22, or other memory. A selector line 36 controls whether the PPA 28 provided from the TLB lookup suppressor 10 or the CPA 32 provided by the TLB 24 as a result of a TLB lookup is provided as the physical address to index the caches 20, 22 or other memory in this embodiment.

In embodiments provided herein, both virtual addresses and physical addresses can be comprised of two portions. Specifically, each address can be comprised of a memory unit address and an offset. In exemplary embodiments, the memory unit address can be a memory page. In such an instance, both a virtual address and its corresponding physical address are comprised of a page address and an offset. The offsets for any pair of corresponding virtual addresses and physical addresses can be the same. Likewise, consider a first virtual address having a first virtual page address that corresponds to a first physical address having a first physical page address. If a second virtual page address of a second virtual address matches the first virtual page address, then the physical page address of the physical address corresponding to the second virtual address is the same as the first physical page address. In short, if two virtual addresses share the same virtual page address, then they also share the same physical page addresses.

Therefore, if a page address of a first virtual address with an unknown associated physical address is compared to a page address of a second virtual address with a known associated physical address and is found to match, then the unknown physical address is fully defined. Specifically, in such an instance, the page address of the known associated physical address combined with the offset derived from the first virtual address yields the full physical address associated with the first virtual address. In an exemplary embodiment, only those bits forming a portion of a prior virtual address (PVA 30) corresponding to the prior virtual page address are received by the comparator 14 from the register 16. For example, only the uppermost bits (e.g., bits 12-31 of a 32-bit virtual address) of the prior virtual address (PVA 30) which correspond to the prior virtual page address need be communicated to the comparator 14.

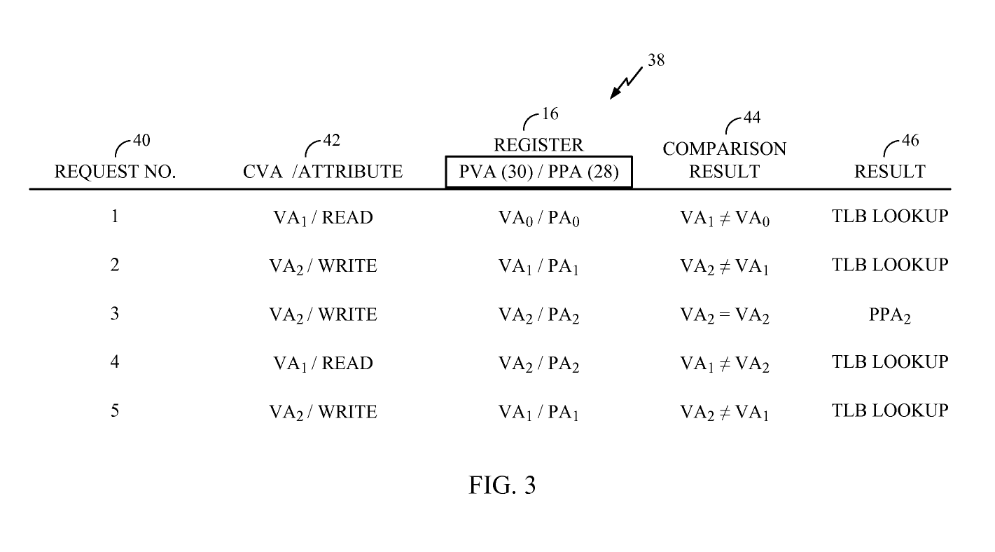

To further illustrate the operation of the TLB lookup suppressor 10 in FIG. 1, FIG. 3 illustrates a table 38 of a sequence of example information requests from the microprocessor 18. The information requests include a virtual address to be translated into a physical address via virtual address translation. For discussion purposes only, each example information request is labeled with a sequential information request number 40 in FIG. 3. Each information request references a CVA 26 (e.g., “VA₁”, “VA₂”) provided by the microprocessor 18 to the TLB lookup suppressor 10. The virtual addresses may be virtual page addresses. The PVA 30 and the PPA 28 stored in the register 16 at the time of each information request by the microprocessor 18 is also shown in the table 38. A comparison result 44 performed by the comparator 14 comparing the CVA 26 to the PVA 30 stored in the register 16 is also provided in the table 38 (see also, block 104 in FIG. 2). If the CVA 26 matches the PVA 30 for a given information request from the microprocessor 18, a result 46 contains the PPA 28 (e.g., see result 46 of information request number “3”: PPA₂). If, however, the CVA 26 does not match the PVA 30 for a given information request, a TLB lookup in the TLB 24 is performed, as indicated in the result 46 as “TLB lookup.”

For example, with reference to the entry for information request number “1” in the table 38, a first current virtual address “VA₁” (CVA 26), which in this example is for a “read” attribute operation, is compared with the a prior virtual address “VA₀” (PVA 30) stored in the register 16. This example assumes that a prior virtual address “VA₀” is stored in the register 16 as a PVA 30 from previous operation of the TLB lookup suppressor 10. The comparison result 44 for information request number “1” is not a match, because “VA₁”≠“VA₀”. The result 46 is a “TLB lookup” in the TLB 24, as shown in the table 38. As a result of this TLB lookup for information request number “1,” the physical address “PA₁” corresponding to “VA₁” resulting from the TLB lookup in the TLB 24 and the current virtual address “VA₁” are stored as the PVA 30 and PPA 28 in the register 16 in case the virtual address for the next request is the same virtual address.

As illustrated in the table 38 in FIG. 3, information request number “2” also results in a TLB lookup because the virtual address provided by the microprocessor 18 in information request number “2” was to virtual address “VA₂” which is not equal to the prior virtual address “VA₁” in information request number “1.” However, note that information request number “3” results in the TLB lookup suppressor 10 suppressing a TLB lookup in the TLB 24, because virtual address “VA₂” was again provided by the microprocessor 18 in information request number “3.” Thus, in information request number “3,” “VA₂” (CVA 26)=“VA₂” (PVA 30). In this regard, the TLB lookup suppressor 10 can simply provide physical address “PA₂” (PPA 28) associated with the virtual address “VA₂” in the register 16 as the physical address to index the caches 20, 22 or other memory without a TLB lookup being performed in the TLB 24. Again, virtual address “VA₂” and the resulting physical address “PA₂” are stored as the PVA 30 and PPA 28 in the register 16, respectively, for subsequent information request number “4.”

As further illustrated in the table 38 in FIG. 3, information request number “4” is not for virtual address “VA₂” previously requested in information request number “3,” but to virtual address “VA₁”. Thus, a TLB lookup occurs for information request number “4” since virtual address “VA₁” does not match virtual address “VA₂” stored in the PVA 30 in the register 16. Information request number “5” is to virtual address “VA₂” like in information request number “3,” but a TLB lookup also occurs for information request number “5” because virtual address “VA₁” and the corresponding physical address “PA₁” were written over virtual address “VA₂” and physical address “PA₂” stored in the PVA 30 and PPA 28 in the register 16, respectively, after information request number “4.” If the PVA 30 and PPA 28 in the register 16 had retained virtual address “VA₂” and physical address “PA₂” after information request number “3” until information request number “5,” a TLB lookup would have been avoided for information request number “5.”

Subsequent information requests having different attributes may often involve different virtual addresses. This results from memory accesses of different attributes often being to different memory pages in memory. Examples of attributes include, but are not limited to, a read, a write, an instruction, an access permission, and a processing privilege. However, there may also be a tendency for subsequent virtual address requests having the same attribute to have a high locality-of-reference, meaning a higher probability of being associated with the same virtual address. In other words, the nearer in time two information requests are received from the microprocessor 18, the more likely that physical page addresses corresponding to the information requests will be the same. This can often result in sequential memory accesses having the same attribute being to the same memory pages in memory. For example, subsequent “read” attribute information request numbers “1” and “4” in the table 38 in FIG. 3 are both addressed to virtual address “VA₁.” Similarly, subsequent “write” attribute information request numbers “2,” “3,” and “5” in the table 38 in FIG. 3 are each addressed to virtual address “VA₂.” The switching between sequential information requests having different attributes may result from substantial interleaving of information requests by the microprocessor 18.

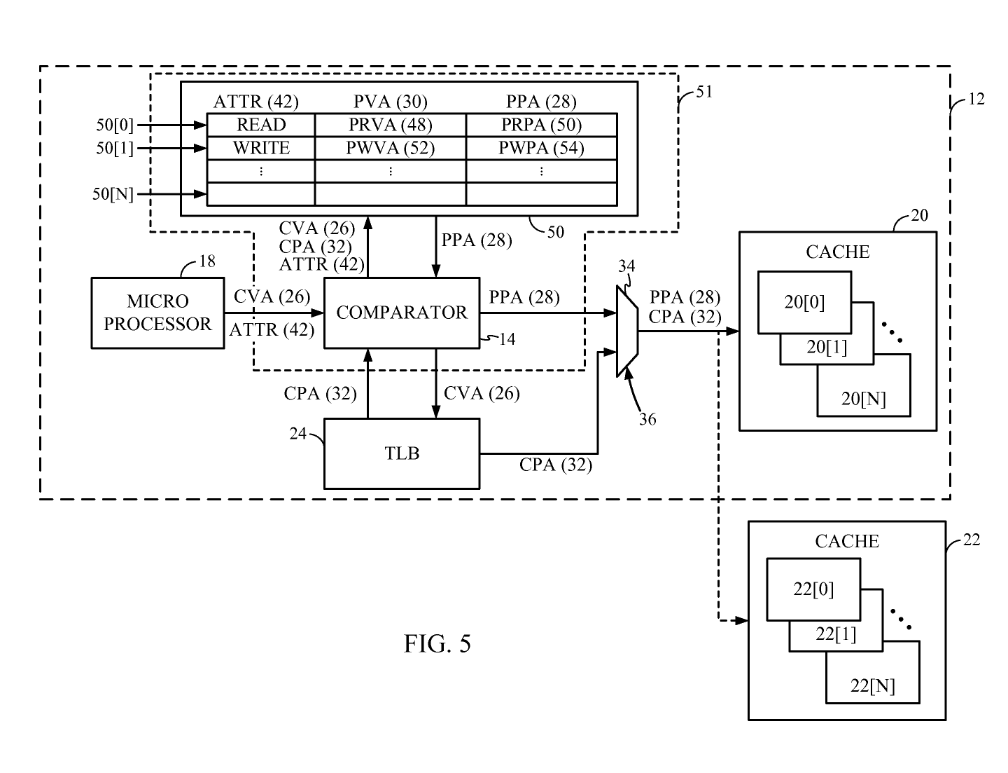

In accordance with exemplary embodiments provided herein, the advantages arising from the recognition of locality-of-reference to reduce TLB lookups in the TLB 24 in FIG. 1 can be further extended to reduce the number of TLB lookups. In this regard, the register 16 could be expanded in size and configured to store the prior virtual address (PVA 30) and associated prior physical address (PPA 28) by each attribute type desired. In this manner, the register 16 can be configured to store the PVA 30 and PPA 28 for each attribute. The TLB lookup suppressor 10 can be configured to store the translated current physical address (CPA 32) for the current virtual address (CVA 26) as a result of TLB lookup in the TLB 24 by attribute type without overwriting the PVA 30 and PPA 28 for other attribute types. This is illustrated by example in a table 48 in FIG. 4 and an exemplary expanded register 50 provided for access by an alternate TLB lookup suppressor 51 in FIG. 5.

As illustrated in FIG. 4, the same information request numbers “1” through “5” having the same CVA 26 and attribute 42 provided in the table 38 in FIG. 3 are provided in the table 48 in FIG. 4. However, in this embodiment, the TLB lookup suppressor 10 is configured to consult the expanded register 50 (also referred to herein as “register 50”). The register 50 contains entries to store prior virtual addresses and corresponding prior physical addresses associated with prior attributes. For example, the register 50 in this embodiment contains a previous “read” attribute virtual address (PRVA 52) and a corresponding previous “read” attribute physical address (PRPA 54) separately from a previous “write” attribute virtual address (PRWA 56) and a corresponding previous “write” attribute physical address (PRPA 58). In this regard, unlike provided in the table 38 in FIG. 3, information request numbers “4” and “5” provided in the table 48 in FIG. 4 will also result in TLB lookup suppression in addition to information request number “3.” This is because the “read” information request number “1” established the virtual address “VA₁” stored in the PRVA 52 and the “write” information request number “2” established the virtual address “VA₂” stored in the PRWA 56, and neither were subsequently overwritten before “information requests numbers “3”, “4,” and “5” to the same virtual addresses were received.

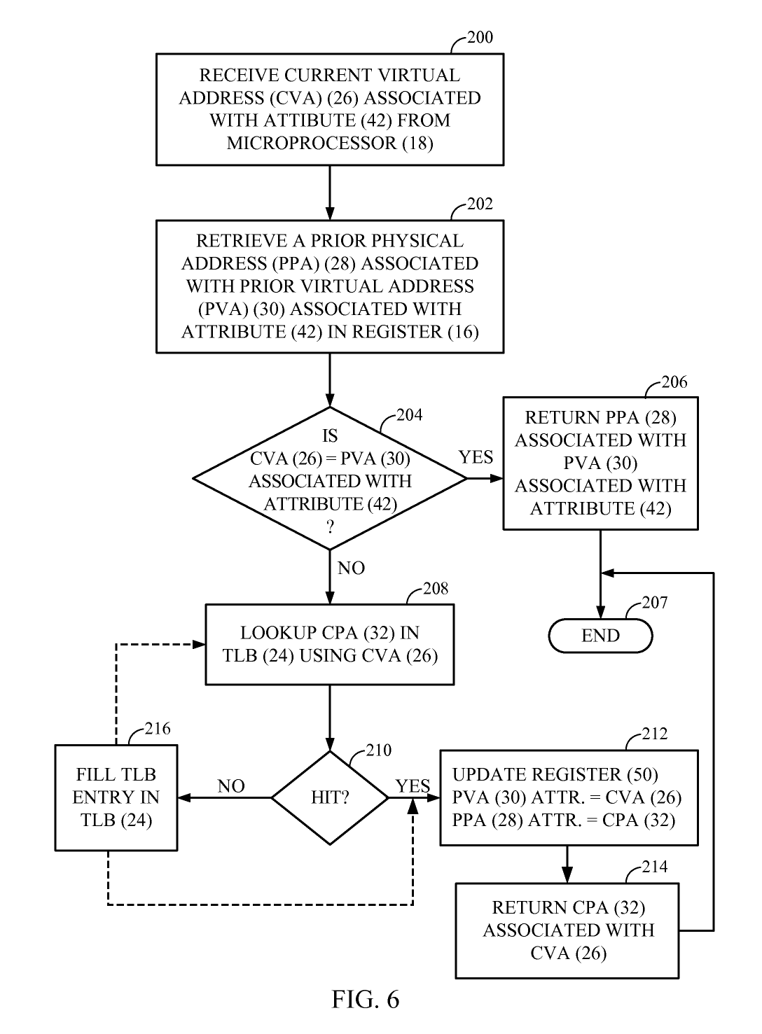

In this regard, the TLB lookup suppressor 51 and its components are similar to the TLB lookup suppressor 10 provided in FIG. 1 as previously described. The other components of the CPU 12 are the same. However, in FIG. 5, the expanded register 50 referenced in the table 48 in FIG. 4 is provided for storing the prior virtual address and prior physical address by attribute type. The TLB lookup suppressor 51 is configured to consult the expanded register 50 by CVA 26 and attribute 42 in this embodiment. Further, in this embodiment, the TLB lookup suppressor 51 is still arranged in a PIPT scheme with regard to the caches 20, 22, like provided by the TLB lookup suppressor 10 in FIG. 1. As illustrated in FIG. 5, the register 50 can contain any number of entries for any number of attributes desired, which is illustrated as N+1 entries (i.e., 50[0]-50[N]) in this example. In this regard, the register 50 can be configured to store the prior virtual address and prior physical address by attribute type other than for only “read” and “write” attributes. FIG. 6 provides a flowchart that illustrates the operation of the TLB lookup suppressor 51 with the register 50 illustrated in FIG. 5 and will be discussed in conjunction with FIG. 5 for further explanation.

As illustrated in FIG. 5 and provided in block 200 in FIG. 6, the TLB lookup suppressor 10 receives a current virtual address (CVA) 26 for accessing information in the cache 20 or cache 22. The TLB lookup suppressor 10 also receives the attribute 42 for the CVA 26 (block 200 in FIG. 6). The CVA 26 is the virtual address for the information currently requested by the microprocessor 18. The comparator 14 of the TLB lookup suppressor 10 retrieves a prior physical address (PPA) 28 based on a prior virtual address (PVA) 30 associated with the attribute 42, which is stored in register 50 (block 202 in FIG. 6). As previously discussed, the register 50 is configured to store prior virtual addresses for each attribute type so that the prior virtual address in the register 50 is not overwritten by subsequent information requests for different attribute types. The comparator 14 next determines if CVA 26 in the information request from the microprocessor 18 is the same virtual address as the PVA 30 stored in the register 50 for the attribute 42 (block 204 in FIG. 6). If the comparator 14 determines that the CVA 26 is the same as the PVA 30 stored in the register 50 for the attribute 42 (block 204 in FIG. 2), this means that the register 50 already contains the physical address (i.e., the PPA 28) associated with the CVA 26 and its attribute. In this regard, a TLB lookup in the TLB 24 to translate the CPA 26 to a physical address is not required since the PPA 28 associated with the PVA 30 and attribute 42 is the same as the CVA 26. Therefore, a TLB lookup is suppressed in the TLB 24 and the power that would otherwise be required to look up the physical address associated with the CVA 26 in the TLB 24 is saved. The TLB lookup suppressor 10 can then output or otherwise provide the stored PPA 28 for the attribute 42 as the physical address to index the cache 20, 22 or other memory, as illustrated in FIG. 5 (block 206 in FIG. 6), and the virtual address translation process ends (block 207 in FIG. 6).

If, however, it is determined that the CVA 26 is not the same as the retrieved PVA 30 stored in the register 50 for the attribute 42 (block 204 in FIG. 6), this means the register 50 did not contain a record of the physical address (i.e., PPA 28) associated with the CVA 26 and its attribute 42. In this regard, the TLB lookup suppressor 10 provides the CVA 26 to the TLB 24 to translate the CVA 26 into a physical address (CPA 32) by performing a TLB lookup (block 208 in FIG. 6). A TLB lookup is performed in this scenario, because the register 50 did not contain the physical address (i.e., PPA 28) associated with the CVA 26 and its attribute 42 (as determined in block 204 in FIG. 6). A determination is then made as to whether the TLB 24 was able to translate the CVA 26 into a corresponding physical address (i.e., CPA 32) (block 210 in FIG. 6). As previously discussed, this may involve the TLB 24 performing a series of comparisons to attempt to match the CVA 26 to virtual addresses stored in the TLB 24. Power is dissipated for each comparison performed.

If the CVA 26 is present in the TLB 24, this means a “hit” has occurred as a result of the TLB lookup. As a result, the TLB 24 communicates the resultant translated physical address (i.e., CPA 32) to the comparator 14 to be stored in the register 50 as the PPA 28 for the PVA 30 by attribute 42 (i.e., PVA (30)_{ATTR.}=CVA (26); PPA (28)_{ATTR.}=CPA (32)) in case the virtual address (i.e., CVA 26) for subsequent information requests from the microprocessor 18 for the same attribute 42 matches the PVA 30 stored in the register 50 for the attribute 42 (block 212 in FIG. 6). In this case, a TLB lookup in the TLB 24 will not be required to perform virtual address translation on the subsequent CVA 26 provided by the microprocessor 18, as discussed above with regard to blocks 200-207 in FIG. 6. After the physical address (i.e., CPA 32) associated with the CVA 26 is retrieved as a result of the TLB hit, the TLB 24 can then output or otherwise provide the CPA 32 as the physical address to index the cache 20, 22 or other memory, as illustrated in FIG. 5 (block 214 in FIG. 6), and the virtual address translation process ends (block 207 in FIG. 6). If the TLB lookup in the TLB 24 (block 208 in FIG. 6) does not result in a hit (block 210 in FIG. 6), the TLB entry in the TLB 24 corresponding to the CVA 26 is filled in with the physical address corresponding to the CVA 26 (i.e., CPA 32) (block 216 in FIG. 6). For example, the TLB entry for the CVA 26 may be generated via a memory page walk.

After the TLB entry for the CVA 26 is generated and filled in the TLB 24 (block 216), the process may repeat the TLB lookup in block 208, as illustrated by the dashed line from block 216 to block 208 in FIG. 6. Alternatively, as illustrated by the dashed line from block 216 to block 212 in FIG. 6, a bypass may be provided to provide the TLB entry for the CVA 26 as the CPA 32 to update the register 16 (block 212) and provide as the physical address for indexing into the caches 20, 22 or other memory. Bypassing the TLB lookup (block 208) after a TLB miss (block 210) may save clock cycles over performing an additional TLB lookup (block 108) after the TLB entry based on the CVA 26 is filled in the TLB 24 (block 116).

Note that the number of entries in register 50[0-N] and the attributes 42 associated with each can be statically defined and implemented. In accordance with other embodiments, attribute values may be dynamically determined, such as by the microprocessor 18, and, in response, both the number and nature of the entries in the register 50[0-N] can be altered. In an exemplary embodiment, the type of attribute or attributes utilized can be determined based upon an analysis of a TLB access pattern comprised of a plurality of requests to the TLB 24. For example, it may be determined that the utility of comparing current attributes related to whether a received virtual address is directed to a “read” from or a “write” to memory may be positively augmented by including one or more entries in the register 50[0-N] indexed by an attribute indicating if the virtual address refers to “data” or to an “instruction.”

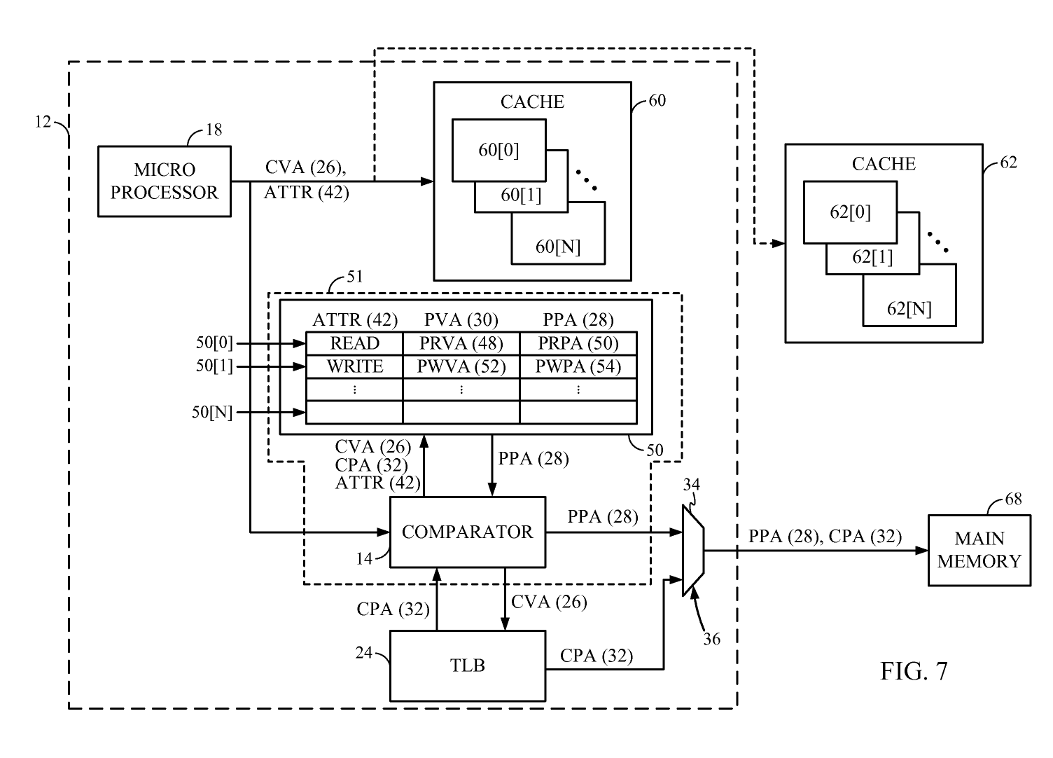

The TLB lookup suppressor 51 may also be employed with indexing schemes other than PIPT, such as virtually indexed, virtually tagged (VIVT) schemes. In this regard, FIG. 7 illustrates the TLB lookup suppressor 51 employed in a VIVT scheme. In this embodiment, level one (L1) cache 60 and level two (L2) cache 62 are provided that are VIVT. The caches 60, 62, being VIVT caches, do not require a physical address to be indexed in this embodiment. Therefore, the CVA 26 and attribute 42 generated by the microprocessor 18 can be provided to the caches 60, 62 independent of the TLB lookup suppressor 51 and TLB 24. The TLB lookup suppressor 51 still operates to determine a physical address for a given CVA 26 and, when doing so, to suppress a TLB lookup in the TLB 24 when possible. Operation of the TLB lookup suppressor 51 may be required in the event that the requested information is not resident in the caches 60, 62. In such a case, a physical address may be required to access a main memory 68 in order to obtain the requested information. Also, there may be other informational bits associated with the physical address, such as access permissions. Access permissions are used to determine whether the software executing in microprocessor 18 is allowed to read or write the data in cache 60, 62.

The TLB lookup suppressors and other components and methods described herein may be used in any type of CPU system, memory circuit, or system. If employed in or with a memory circuit or system, the memory circuit or system may employ any type of memory. Examples include, without limitation, static random access memory (RAM) (SRAM), dynamic RAM (DRAM), synchronous DRAM (SDRAM), data-double-rate (DDR) SDRAM, data-double-rate-two (DDR2) SDRAM, data-double-rate-three (DDR3) SDRAM, Mobile DDR (MDDR) SDRAM, low-power (LP) DDR SDRAM, and LP DDR2 SDRAM.

The TLB lookup suppressors and other components and methods described herein may be included or integrated in a semiconductor die, integrated circuit, and/or device, including an electronic device and/or processor-based device or system. Examples of such devices include, without limitation, a set top box, an entertainment unit, a navigation device, a communications device, a personal digital assistant (PDA), a fixed location data unit, a mobile location data unit, a mobile phone, a cellular phone, a computer, a portable computer, a desktop computer, a monitor, a computer monitor, a television, a tuner, a radio, a satellite radio, a music player, a digital music player, a portable music player, a video player, a digital video player, a digital video disc (DVD) player, and a portable digital video player.

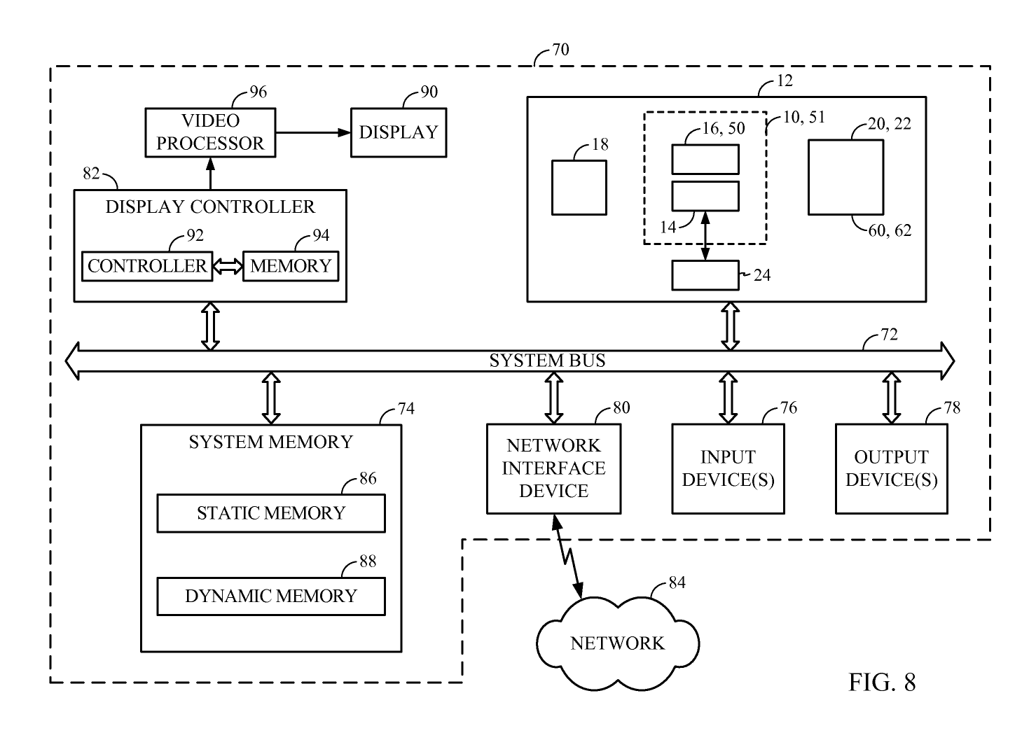

In this regard, FIG. 8 illustrates an example of a processor-based system 70 that can employ the CPU 12 and TLB lookup suppressor 10 or 51, as previously described and according to any of the embodiments disclosed herein. In this example, the processor-based system 70 includes the CPU 12 that includes either the TLB lookup suppressor 10 or 51, the register 16 or 50, the microprocessor 18, caches 20, 22 or 60, 62 and the TLB 24. The TLB lookup suppressor 10, 51 can be provided in the CPU 12 in a PIPT or VIVT configuration. As previously discussed, if a PIPT configuration is employed, PIPT cache 20, 22 can be provided. If a VIVT configuration is employed, VIVT cache 60, 62 can be provided. The CPU 12 is coupled to a system bus 72, which intercouples the other devices included in the processor-based system 70. As is well known, the CPU 12 communicates with these other devices by exchanging address, control, and data information over the system bus 72. These devices can include any types of devices. As illustrated in FIG. 8, these devices can include system memory 74, one or more input devices 76, one or more output devices 78, a network interface device 80, and a display controller 82, as examples.

The input devices 76 can include any type of input device, including but not limited to input keys, switches, voice processors, etc. The output devices 78 can include any type of output device, including but not limited to audio, video, other visual indicators, etc. The network interface device 80 can be any device configured to allow exchange of data to and from a network 84. The network 84 can be any type of network, including but not limited to a wired or wireless network, private or public network, a local area network (LAN), a wide local area network (WLAN), and the Internet. The network interface device 80 can support any type of communication protocol desired. The CPU 12 can access the system memory 74 over the system bus 72. The system memory 74 can include static memory 86 and/or dynamic memory 88.

The CPU 12 can also access the display controller 82 over the system bus 72 to control information sent to a display 90. The display controller 82 can include a memory controller 92 and memory 94 to store data to be sent to the display 90 in response to communications with the CPU 12. The display controller 82 sends information to the display 90 to be displayed via a video processor 96, which processes the information to be displayed into a format suitable for the display 90. The display 90 can include any type of display, including but not limited to a cathode ray tube (CRT), a liquid crystal display (LCD), a plasma display, etc.

Those of skill in the art would further appreciate that the various illustrative logical blocks, modules, circuits, and algorithm steps described in connection with the embodiments disclosed herein can be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may store and compare any type of data, including but not limited to tag data, and may be implemented or performed with any signal levels to provide logical true and logical false. Logical true can be represented as a logical high (“1,” V_{DD}) and logical false as a logical low (“0,” V_{SS}), or vice versa. The various illustrative logical blocks, modules, and circuits described in connection with the embodiments disclosed herein can also be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor can be a microprocessor, but in the alternative, the processor can be any conventional processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration.

It is noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. It is to be understood that the operational steps illustrated in the flowchart diagrams may be subject to numerous different modifications as will be readily apparent to one of skill in the art. Those of skill in the art would also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The steps of a method or algorithm described in connection with the embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A circuit for performing virtual address translation, comprising:
a comparator configured to receive as an input a current virtual address and a current attribute associated with the current virtual address, and a prior physical address and a prior virtual address each associated with the current attribute,
wherein the comparator is further configured to cause the prior physical address to be provided as a current physical address if the current virtual address matches the prior virtual address associated with the current attribute.

2. The circuit of claim 1, wherein the circuit is further configured to suppress a TLB lookup if the current virtual address matches the prior virtual address.

3. The circuit of claim 1, further comprising at least one register configured to store one or more of the current attribute, the prior virtual address, and the prior physical address.

4. The circuit of claim 1, wherein the circuit is further configured to:
receive a current physical address associated with the current virtual address; and
if the current virtual address does not match the prior virtual address, store the current physical address as the prior physical address and the current virtual address as the prior virtual address in at least one register.

5. The circuit of claim 1, wherein the current virtual address comprises a current memory unit address and a current offset, and the prior virtual address comprises a prior memory unit address and a prior offset.

6. The circuit of claim 5, wherein both the current memory unit address and the prior memory unit address each comprise a memory page.

7. The circuit of claim 1, wherein the attribute is selected from a group consisting of a read, a write, data, an instruction, an access permission, and a processing privilege.

8. The circuit of claim 1, wherein a type of the current attribute was dynamically determined.

9. The circuit of claim 8, wherein the type of the current attribute is based upon a locality-of-reference.

10. The circuit of claim 8, wherein the type of the current attribute is based upon a TLB access pattern.

11. The circuit of claim 1 integrated in at least one semiconductor die.

12. The circuit of claim 1, further comprising a device selected from a group consisting of a set top box, an entertainment unit, a navigation device, a communications device, a personal digital assistant (PDA), a fixed location data unit, a mobile location data unit, a mobile phone, a cellular phone, a computer, a portable computer, a desktop computer, a monitor, a computer monitor, a television, a tuner, a radio, a satellite radio, a music player, a digital music player, a portable music player, a video player, a digital video player, a digital video disc (DVD) player, and a portable digital video player, into which the circuit is integrated.

13. A circuit for providing virtual address translation, comprising:
a means for receiving as an input a current virtual address and a current attribute associated with the current virtual address, and a prior physical address and a prior virtual address each associated with the current attribute; and
a means for causing the prior physical address to be provided as a current physical address if the current virtual address matches the prior virtual address associated with the current attribute.

14. A method for performing virtual address translation, comprising:
receiving as input a current virtual address and a current attribute associated with the current virtual address;
receiving both a prior physical address and a prior virtual address each associated with the current attribute; and
providing the prior physical address as a current physical address if the current virtual address matches the prior virtual address associated with the current attribute.

15. The method of claim 14, further comprising suppressing a TLB lookup if the current virtual address matches the prior virtual address associated with the current attribute.

16. The method of claim 14, further comprising storing one or more of the current attribute, the prior virtual address, and the prior physical address in at least one register.

17. The method of claim 14, further comprising receiving a current physical address associated with the current virtual address and storing a current physical address as the prior physical address and storing the current virtual address as the prior virtual address in at least one register if the current virtual address does not match the prior virtual address.

18. The method of claim 14, wherein the current attribute was dynamically determined.

19. The method of claim 18, wherein the type of the current attribute is determined based upon a locality-of-reference.

20. The method of claim 18, wherein the type of the current attribute is based upon a TLB access pattern.

21. The method of claim 14, wherein determining if the current virtual address matches the prior virtual address comprises determining if a current memory unit address matches a prior memory unit address.
